(19) United States
(12) Patent Application Publication
(10) Pub. No.: US 2020/0102873 A1
(43) Pub. Date: Apr. 2, 2020

(54) DIESEL EMISSIONS FLUID INJECTOR MIXER

(71) Applicant: GM GLOBAL TECHNOLOGY OPERATIONS LLC, DETROIT, MI (US)

(72) Inventors: Fabrizio Ramolivo, Canale (Cuneo) (IT); Ivan Flaminio Cozza, Torino (TO) (IT); Alessandro Sarsano, Turin (IT)

(21) Appl. No.: 16/144,250

(22) Filed: Sep. 27, 2018

(51) Int. Cl. F01N 3/28; B01F 5/04; B01F 5/06

(52) U.S. Cl. CPC F01N 3/2892; B01F 5/0451; F01N 2610/1453; F01N 2240/20; F01N 2610/02; B01F 5/0614

(57) ABSTRACT

A mixer element of an exhaust treatment apparatus for an internal combustion engine includes a semi-tube having a closed first end and an open second end. The first end includes a fluid inlet configured for connection to an emission fluid injector of the exhaust treatment apparatus. The semi-tube is configured to induce swirl into an exhaust gas flow across the semi-tube. A plurality of bladed discs are spaced axially apart along a tube axis of the semi-tube. The plurality of bladed discs are configured and positioned to induce a helical component to the exhaust gas flow relative to the tube axis. Each bladed disc includes a plurality of blades extending from a disc hub.

### INTRODUCTION

The subject disclosure relates to internal combustion engines, and more particularly, to exhaust after treatment systems of internal combustion engines.

Manufacturers of internal combustion engines, more particularly diesel engines, are presented with the challenging task of complying with current and future emission standards for the release of nitrogen oxides, particularly nitrogen oxides (NOx), as well as unburned and partially oxidized hydrocarbons, carbon monoxide, and particulate matter. In order to reduce the constituent emissions of a diesel engine, an exhaust gas after treatment system is used to reduce exhaust constituents within the exhaust gas flowing from the engine.

Exhaust gas after treatment systems typically include one or more after treatment devices, such as oxidation catalysts, catalytic converters, and emissions fluid injectors. Emissions fluid injectors for diesel engines (also called diesel emissions fluid injectors or DEF injectors) may inject a urea or other suitable ammonia based fluid into the exhaust flow to improve the performance of catalytic converters. Further, mixer elements are sometimes used to facilitate urea and exhaust gas mixing to improve catalytic converter operation.

In many systems, a distance along the exhaust gas path between the DEF injector and the catalytic converter is short due to packaging constraints. As such, a low vaporization of the liquid is experienced, which lowers the efficiency of the exhaust gas after treatment system, and reduces durability of the system due to crystallization of the liquid.

### SUMMARY

In one embodiment, a mixer element of an exhaust treatment apparatus for an internal combustion engine includes a semi-tube having a closed first end and an open second end. The first end includes a fluid inlet configured for connection to an emission fluid injector of the exhaust treatment apparatus. The semi-tube is configured to induce swirl into an exhaust gas flow across the semi-tube. A plurality of bladed discs are spaced axially apart along a tube axis of the semi-tube. The plurality of bladed discs are configured and positioned to induce a helical component to the exhaust gas flow relative to the tube axis. Each bladed disc includes a plurality of blades extending from a disc hub.

Additionally or alternatively, in this or other embodiments the blades of axially adjacent bladed discs are circumferentially offset thereby inducing the helical component to the exhaust gas flow.

Additionally or alternatively, in this or other embodiments the blades of axially adjacent bladed discs are circumferentially offset by an offset angle of between 1 degree and 45 degrees.

Additionally or alternatively, in this or other embodiments the blades of axially adjacent bladed discs are circumferentially offset to obscure a tube passage of the semi-tube in a plane perpendicular to the tube axis.

Additionally or alternatively, in this or other embodiments the bladed discs are secured to the semi-tube.

Additionally or alternatively, in this or other embodiments the plurality of bladed discs is between 2 and 6 bladed discs.

Additionally or alternatively, in this or other embodiments each bladed disc has three blades.

Additionally or alternatively, in this or other embodiments the semi-tube has a circumferential open angle defined between a first circumferential end of the semi-tube and a second circumferential end of the semi-tube.

Additionally or alternatively, in this or other embodiments the circumferential open angle is in the range of 160 degrees to 180 degrees.

Additionally or alternatively, in this or other embodiments the semi-tube includes a plurality of tube perforations.

In another embodiment, an exhaust treatment apparatus for an internal combustion engine includes an exhaust gas pathway, a catalytic converter positioned along the exhaust pathway, and an emission fluid injector positioned along the exhaust pathway configured to inject an emission fluid into the exhaust pathway upstream of the catalytic converter. A mixer element is configured to mix the emission fluid with an exhaust gas flow in the exhaust pathway and includes a semi-tube having a closed first end and an open second end. The first end includes a fluid inlet configured for connection to the emission fluid injector of the exhaust treatment apparatus. The semi-tube is configured to induce swirl into the exhaust gas flow across the semi-tube. A plurality of bladed discs are spaced axially apart along a tube axis of the semi-tube. The plurality of bladed discs are configured and positioned to induce a helical component to the exhaust gas flow relative to the tube axis. Each bladed disc includes a plurality of blades extending from a disc hub.

Additionally or alternatively, in this or other embodiments the blades of axially adjacent bladed discs are circumferentially offset thereby inducing the helical component to the exhaust gas flow.

Additionally or alternatively, in this or other embodiments the blades of axially adjacent bladed discs are circumferentially offset by an offset angle of between 1 degree and 45 degrees.

Additionally or alternatively, in this or other embodiments the blades of axially adjacent bladed discs are circumferentially offset to obscure a tube passage of the semi-tube in a plane perpendicular to the tube axis.

Additionally or alternatively, in this or other embodiments the bladed discs are secured to the semi-tube.

Additionally or alternatively, in this or other embodiments the plurality of bladed discs is between 2 and 6 bladed discs.

Additionally or alternatively, in this or other embodiments each bladed disc has three blades.

Additionally or alternatively, in this or other embodiments the semi-tube has a circumferential open angle defined between a first circumferential end of the semi-tube and a second circumferential end of the semi-tube.

Additionally or alternatively, in this or other embodiments the circumferential open angle is in the range of 160 degrees to 180 degrees.

Additionally or alternatively, in this or other embodiments the semi-tube includes a plurality of tube perforations.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of an embodiment of an internal combustion engine and an exhaust system;

FIGS. 2A and 2B are schematic views of embodiments of exhaust after treatment systems;

FIG. 3 is a side view of an embodiment of a mixer element;

FIG. 4 is an end view of an embodiment of a semi-tube of a mixer element;

FIG. 5 is a perspective view of an embodiment of a mixer element; and

FIG. 6 is an end view of an embodiment of a mixer element.

### DETAILED DESCRIPTION

The following description is merely exemplary in nature and is not intended to limit the present disclosure, its application or uses. It should be understood that throughout the drawings, corresponding reference numerals may indicate like or corresponding parts and features.

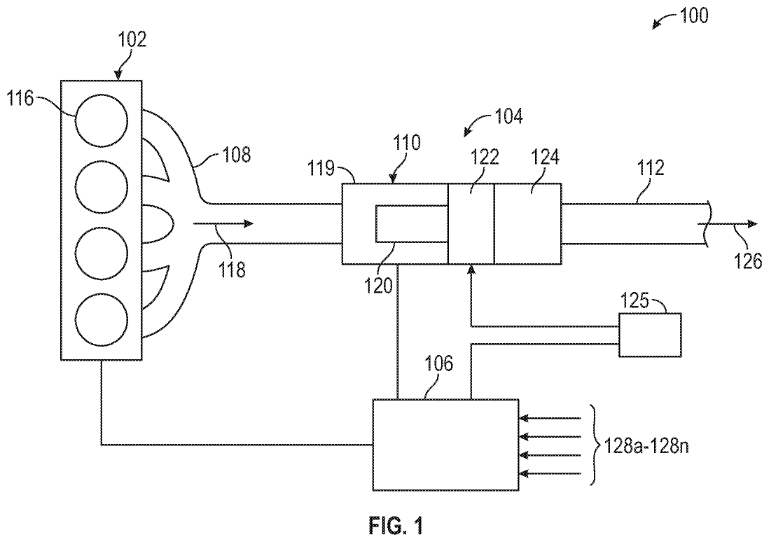

FIG. 1 is a schematic diagram of an embodiment of an engine system 100. The engine system 100 includes an internal combustion engine 102, an exhaust system 104 and an engine controller 106. The exhaust system 104 includes an exhaust manifold 108, an exhaust after treatment apparatus 110 and an exhaust conduit 112. Cylinders 116 are located in internal combustion engine 102, wherein the cylinders receive a combination of combustion air and fuel. The combustion air/fuel mixture is combusted resulting in reciprocation of pistons (not shown) located in the cylinders 116. The reciprocation of the pistons rotates a crankshaft (not shown) to deliver motive power to a vehicle powertrain (not shown) or to a generator or other stationary recipient of such power (not shown) in the case of a stationary application of the internal combustion engine 102. The combustion of the air/fuel mixture causes a flow of exhaust gas 118 through the exhaust manifold 108 and into the exhaust gas after treatment apparatus 110, wherein the exhaust after treatment apparatus 110 includes an exhaust gas conduit 119, an oxidation catalyst 120, a mixer element 122 and a catalytic converter 124. The exhaust after treatment apparatus 110 reduces or treats various regulated constituents of the exhaust gas 118 prior to its release to the atmosphere. In an exemplary embodiment, the mixer element 122 receives a fluid supply 125 used to treat diesel exhaust gas 118 flow to conform with emissions regulations. In addition, an exemplary fluid supply 125 that includes a fluid to be mixed with exhaust gas 118, such as a urea solution that may be referred to as a diesel emission fluid or emission fluid. In exemplary embodiments, the process of reducing exhaust constituents within the catalytic converter 124 is improved by mixing urea and exhaust gas, wherein the treated exhaust 126 is released through exhaust conduit 112 to the atmosphere.

The exhaust after treatment apparatus 110 and fluid supply 125 are operationally coupled to and controlled by engine controller 106. The engine controller 106 collects information regarding the operation of the internal combustion engine 102 from sensors 128a-128n, such as temperature (intake system, exhaust system, engine coolant, ambient, etc.), pressure, exhaust flow rates, NOx concentrations and, as a result, may adjust the amount of fluid injected into mixer element 122. As used herein the term controller refers to an application specific integrated circuit (ASIC), an electronic circuit, a processor (shared, dedicated or group) and memory that executes one or more software or firmware programs, a combinational logic circuit, and/or other suitable components that provide the described functionality. As depicted, fluid supply 125 is used in catalytic reduction reactions to reduce constituents in exhaust gases. Fluid supply 125 may include any suitable fluid that can be mixed with exhaust gas from internal combustion engines for the purpose of emission reduction, such as a urea solution for NOx emission reduction and/or hydrocarbons for diesel particulate filter regeneration. In an exemplary exhaust after treatment apparatus 110, the fluid supply 125 includes a water-based urea solution injected into the exhaust gas 118. The ammonia produced by hydrolysis of the urea reacts with the nitrogen oxide emissions and is converted into nitrogen and water within the catalytic converter 124, thereby reducing exhaust gas emissions of the internal combustion engine 102.

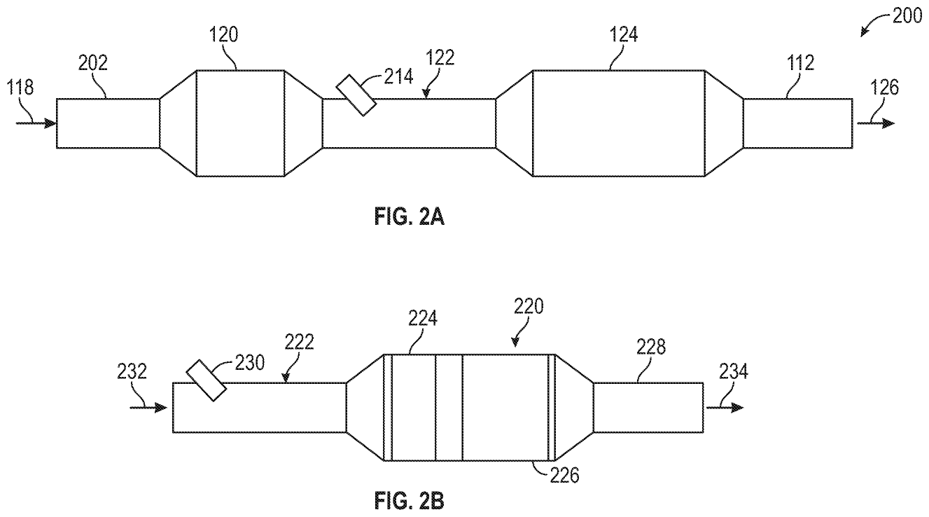

FIG. 2A is a side view of an exemplary exhaust after treatment apparatus 200. The exhaust after treatment apparatus 200 receives exhaust gas flow 118 from internal combustion engine 102 (FIG. 1). The exhaust after treatment apparatus 200 includes conduit 202, oxidation catalyst 120, fluid injector 214, mixer element 122, catalytic converter 124 and exhaust gas conduit 112. An exemplary fluid injector 214 injects a supply of emission fluid into a flow of the exhaust gas 118 to be mixed within mixer element 122 prior to its entry into the catalytic converter 124. The mixer element 122 is configured to evenly distribute the injected emission fluid with the exhaust gas flow. Accordingly, the improved distribution of the emission fluid, such as urea, in the form of droplets, within the exhaust gas flow 118 enhances the performance of catalytic converter 124.

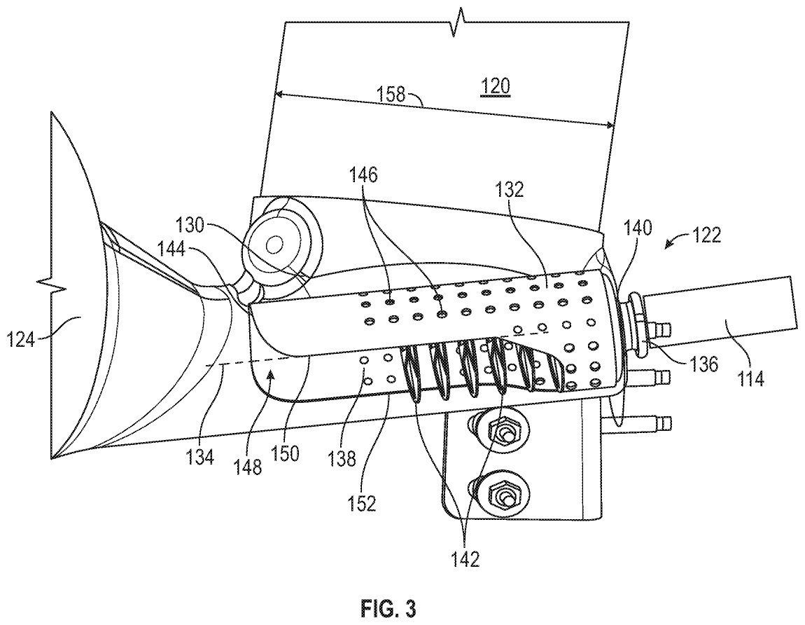

FIG. 2B is a side view of another exemplary exhaust after treatment apparatus 220. The exhaust after treatment apparatus 220 receives exhaust gas flow 232 from internal combustion engine 102 (FIG. 1). The exhaust after treatment apparatus 220 includes mixer element 222, oxidation catalyst 224, particulate filter 226, exhaust conduit 228 and fluid injector 230. In an exemplary embodiment, fluid injector 230 injects a fluid supply of hydrocarbons into the exhaust gas flow 232 to be mixed within or by mixer element 222 prior to its entry into oxidation catalyst 224. The mixer element 222 is configured to evenly distribute the injected fluid with the exhaust gas flow 232. Accordingly, the improved distribution of hydrocarbons within the exhaust gas flow 232 enhances the performance of the oxidation catalyst 224 and particulate filter 226, thereby providing a treated exhaust gas 234 to be released into the atmosphere. FIGS. 3-6 discuss detailed exemplary embodiments of mixer elements 122, 222 that may be used in either embodiment of exhaust after treatment device 200, 220 shown in FIGS. 2A and 2B.

Referring to FIG. 3, the mixer element 122 is located in a transfer tube 130 of the exhaust pathway between the oxidation catalyst 120 and the catalytic converter 124. The mixer element 122 includes a semi-tube 132 extending axially along a tube axis 134, and circumferentially partially about the tube axis 134. A fluid inlet 136 is connected to the fluid injector 114 through which the emission fluid is directed from the fluid injector 114 into a tube passage 138 of the semi-tube 132. In some embodiments, the fluid inlet 136 is located along the tube axis 134 at a first end 140 of the mixer element 122. One or more bladed discs 142 are located in the tube interior 138, in some embodiments, at and perpendicular to the tube axis 134.

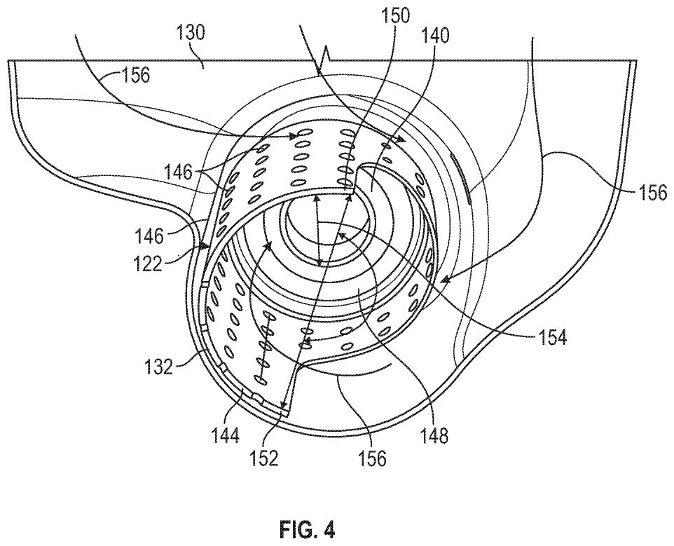

Referring now to the end view of FIG. 4, the mixer element 122 is illustrated with the bladed discs 142 removed for clarity. The semi-tube 132 is open at a second tube end 144 opposite the first tube end 140. The semi-tube 132 further includes a plurality of tube perforations 146 in the semi-tube 132. The tube perforations 146 have a perforation diameter, which in some embodiments is in the range of 4-6 millimeters. Those perforations are utilized to improve permeability of the exhaust gas flow passage. The semi-tube 132 has a circumferential open angle 148 defined between a first circumferential end 150 and a second circumferential end 152 of the semi-tube 132, which in some embodiments is in the range of 160 degrees to 180 degrees. Further, the first circumferential end 150 is located off of vertical, relative to the tube axis 134, at an offset angle 154 which in some embodiments is between 5 degrees and 10 degrees. The open angle 148 and the offset angle 154 induces swirl in an exhaust gas flow 156 flowing across the mixer element 122.

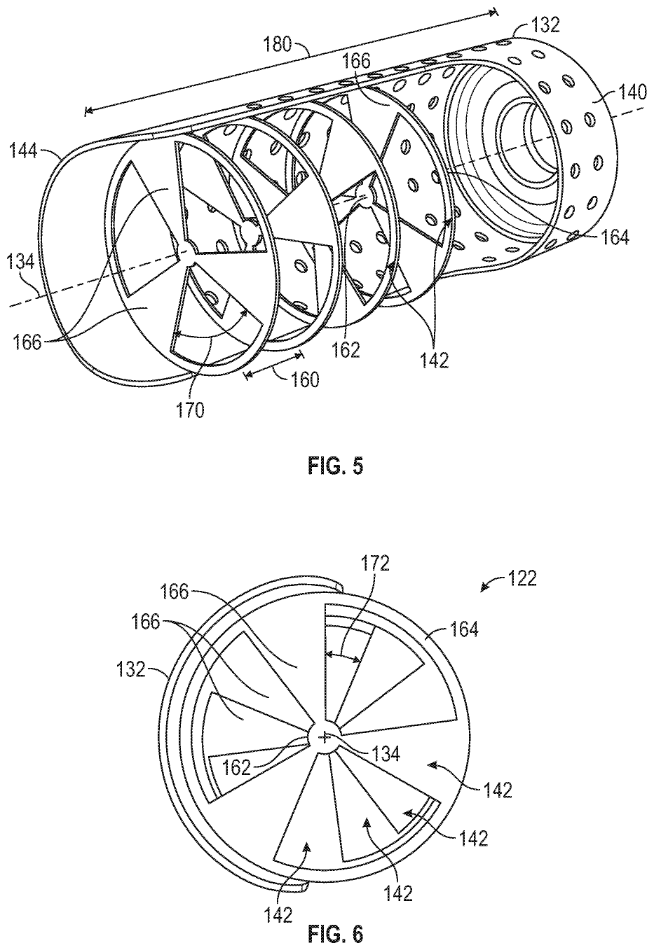

Referring now to FIG. 5, the semi-tube 132 has a tube length 180 from the first tube end 140 to the second tube end 144. In some embodiments, the tube length 180 is selected relative to an oxidation catalyst diameter 158 (shown in FIG. 3), where the tube length 180 is between 0.9 and 1.1 times the oxidation catalyst diameter 158. The one or more bladed discs 142 are spaced along the tube axis 134 by a disc distance 160. In some embodiments, the disc distance 160 is expressed as the number of bladed discs 142 divided by the oxidation catalyst diameter 158. In some embodiments, between two and six bladed discs 142 are utilized, while in another embodiment, the mixer element 122 includes 4 bladed discs 142. Each bladed disc 142 includes a disc hub 162 located at the tube axis 134, a disc rim 164 spaced from the disc hub 162, and a plurality of disc blades 166 extending between the disc hub 162 and the disc rim 164. The bladed discs 142 are secured to the semi-tube 132 by, for example, welding or brazing the disc rim 164 to the semi-tube 132. In other embodiments, the semi-tube 132 and the bladed discs 142 may be formed as a single unitary component by, for example, additive manufacturing. In one embodiment, each bladed disc 142 includes three disc blades 166. In some embodiments, the quantity of disc blades 166 equals a number of injector spray openings (not shown) of the fluid injector 114. The disc blades 166 of each bladed disc 142 are circumferentially spaced by a blade angle 170. In some embodiments, the disc blades 166 are equally spaced. While the bladed discs 142 shown in the embodiment of FIG. 5 are identically configured, one skilled in the art will readily appreciate that in some embodiments adjacent bladed discs 142 may have different configurations, including quantity of disc blades 166 and/or spacing of disc blades 166.

Referring now to the end view of FIG. 6, blade positions of the disc blades 166 of axially adjacent bladed discs 142 are angularly offset about the tube axis 134. In some embodiments, an angular offset angle 172 is between 1 degree and 45 degrees. Such an angular offset of the disc blades 166 induces a helical component to the exhaust gas flow 156 in the mixer element 122, relative to the tube axis 134. The swirl of the exhaust gas flow 156, and the helical exhaust gas flow 156 both promote mixing and vaporization of the emission fluid injected from the fluid injector 114 into the exhaust gas flow 156 prior to reaching the catalytic converter 124. Further, as shown in FIG. 6, the disc blades 166 of the plurality of bladed discs 142 completely obscure the tube passage 138 when viewed from a plane perpendicular to the tube axis 134 at the second tube end 144, thereby preventing unmixed emission fluid from reaching the catalytic converter 124.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A mixer element of an exhaust treatment apparatus for an internal combustion engine, comprising:
a semi-tube having a closed first end and an open second end, the first end including a fluid inlet configured for connection to an emission fluid injector of the exhaust treatment apparatus, the semi-tube configured to induce swirl into an exhaust gas flow across the semi-tube; and
a plurality of bladed discs spaced axially apart along a tube axis of the semi-tube, the plurality of bladed discs configured and disposed to induce a helical component to the exhaust gas flow relative to the tube axis, each bladed disc including a plurality of blades extending from a disc hub.

2. The mixer element of claim 1, wherein the blades of axially adjacent bladed discs are circumferentially offset thereby inducing the helical component to the exhaust gas flow.

3. The mixer element of claim 2, wherein the blades of axially adjacent bladed discs are circumferentially offset by an offset angle of between 1 degree and 45 degrees.

4. The mixer element of claim 2, wherein the blades of axially adjacent bladed discs are circumferentially offset to obscure a tube passage of the semi-tube in a plane perpendicular to the tube axis.

5. The mixer element of claim 1, wherein the bladed discs are secured to the semi-tube.

6. The mixer element of claim 1, wherein the plurality of bladed discs is between 2 and 6 bladed discs.

7. The mixer element of claim 1, wherein each bladed disc has three blades.

8. The mixer element of claim 1, wherein the semi-tube has a circumferential open angle defined between a first circumferential end of the semi-tube and a second circumferential end of the semi-tube.

9. The mixer element of claim 8, wherein the circumferential open angle is in the range of 160 degrees to 180 degrees.

10. The mixer element of claim 1, wherein the semi-tube includes a plurality of tube perforations.

11. An exhaust treatment apparatus for an internal combustion engine, comprising:
an exhaust gas pathway;
a catalytic converter disposed along the exhaust pathway;
an emission fluid injector disposed along the exhaust pathway configured to inject an emission fluid into the exhaust pathway upstream of the catalytic converter; and
a mixer element configured to mix the emission fluid with an exhaust gas flow in the exhaust pathway, the mixer element including:
a semi-tube having a closed first end and an open second end, the first end including a fluid inlet configured for connection to the emission fluid injector of the exhaust treatment apparatus, the semi-tube configured to induce swirl into the exhaust gas flow across the semi-tube; and
a plurality of bladed discs spaced axially apart along a tube axis of the semi-tube, the plurality of bladed discs configured and disposed to induce a helical component to the exhaust gas flow relative to the tube axis, each bladed disc including a plurality of blades extending from a disc hub.

12. The exhaust treatment apparatus of claim 11, wherein the blades of axially adjacent bladed discs are circumferentially offset thereby inducing the helical component to the exhaust gas flow.

13. The exhaust treatment apparatus of claim 12, wherein the blades of axially adjacent bladed discs are circumferentially offset by an offset angle of between 1 degree and 45 degrees.

14. The exhaust treatment apparatus of claim 12, wherein the blades of axially adjacent bladed discs are circumferentially offset to obscure a tube passage of the semi-tube in a plane perpendicular to the tube axis.

15. The exhaust treatment apparatus of claim 11, wherein the bladed discs are secured to the semi-tube.

16. The exhaust treatment apparatus of claim 11, wherein the plurality of bladed discs is between 2 and 6 bladed discs.

17. The exhaust treatment apparatus of claim 11, wherein each bladed disc has three blades.

18. The exhaust treatment apparatus of claim 11, wherein the semi-tube has a circumferential open angle defined between a first circumferential end of the semi-tube and a second circumferential end of the semi-tube.

19. The exhaust treatment apparatus of claim 18, wherein the circumferential open angle is in the range of 160 degrees to 180 degrees.

20. The exhaust treatment apparatus of claim 11, wherein the semi-tube includes a plurality of tube perforations.
